(19) United States
(12) Patent Application Publication
(10) Pub. No.: US 2009/0314919 A1
(43) Pub. Date: Dec. 24, 2009

(54) Suspension Seat Mechanism

(75) Inventors: Luigi J. Toffolo, Wilton, CT (US); Walker P. Woodworth, Wilton, CT (US); Frederick W. Kinzler, Trumbull, CT (US)

Correspondence Address: Walker Woodworth, 8 Coachman's Place, Wilton, CT, 06897, US

(73) Assignee: Frank Roth Co., Inc., Stratford, CT (US)

(21) Appl. No.: 12/456,869

(22) Filed: Jun. 24, 2009

Related U.S. Application Data
(60) Provisional application No. 61/132,983, filed on Jun. 24, 2008.

(51) Int. Cl. B63B 29/06; F16M 11/26; A47C 3/40; B63B 29/00; B63B 17/00

(52) U.S. Cl. 248/560

(57) ABSTRACT

In a preferred embodiment, a light weight telescoping suspension seat mechanism for a watercraft seat pedestal designed to fit into an existing or new seat pedestal. This suspension seat mechanism contains a combination of roller bearings to allow the seat pedestal to move linearly, but not rotationally. An expanding bushing mechanism secures the seat assembly rigidly to the seat pedestal and floor, and another bushing connects the mechanism to the seat. Each are easily adjusted to allow for easy installation and removal of the suspension seat mechanism. Located inside the telescoping mechanism is a suspension damper with air rebound spring allowing the individual to tailor the suspension stiffness to individual preference. This suspension mechanism provides damping force on the seat. The rebound spring responds to seat movement so as to return the seat to its original position.

### RELATED APPLICATIONS

| | | |
|---|---|---|
| 1,400,974 | December 1921 | Parker |
| 2,029,247 | January 1936 | Mercogliano |
| 2,713,892 | July 1955 | Kanpp. |
| 2,855,984 | October 1958 | Majorana et al. |
| 2,893,470 | July 1959 | Peller |
| 3,055,708 | September 1962 | Baermann |
| 3,171,691 | March 1965 | Buehrig |
| 3,462,196 | August 1969 | Arnold et al. |
| 3,656,807 | April 1972 | Arida et. Al. |
| 3,762,770 | October 1973 | Tedesco et al. |
| 3,985,388 | October 1976 | Hogan |
| 4,123,105 | October 1978 | Frey et al. |
| 4,128,217 | December 1978 | Mazlesky |
| 4,147,336 | April 1979 | Yamawaki et al. |
| 4,150,805 | April 1979 | Mazlesky |
| 4,362,335 | December 1982 | Drabert et al. |
| 4,519,651 | May 1985 | Whitman |
| 4,711,497 | December 1987 | Kazaoka et al. |
| 5,405,179 | April 1995 | Jih |
| 5,320,374 | June 1994 | Farris et al. |
| 5,746,152 | May 1998 | Huse |
| 6,116,183 | September 2000 | Crow et al. |
| 6,138,973 | October 2000 | Woodward |
| 7,008,015 B2 | March 2006 | Bischoff |
| 7,017,872 | March 2006 | Hogle et al. |

### BACKGROUND OF THE INVENTION

1. Field of the Invention

The present invention relates to suspension devices and the like designed to mitigate the shock imposed on people. More particularly this invention relates to seat suspension assemblies for use in watercraft.

It is well known that people riding in boats or other watercrafts experience jarring and an unsettling ride as the boat moves through the water. The enjoyment of the ride is diminished based on the severity of the shock. In addition, in extreme cases, injuries or sustained discomfort can occur. Various suspension seats and suspension pedestals have been proposed to mitigate the shock. Many of these designs offer a higher degree of comfort by incorporating foam padding in the seat structure. Some incorporate spring devices to ameliorate the shock transmitted from the boat. Many require the purchase of an entire seat to obtain the shock absorbing benefits, thus they are expensive and require more effort to incorporate into an existing boat structure.

One popular style of seat structure involves a seat mounted to a seat pedestal typically made from aluminum tubes. One end of the tube is mounted to the deck of the boat through a mounting base and the other end has the seat mounted to it. The seat typically has a base with a flange that is mounted about the tube. In most applications, the seat swivels to allow the seat to turn 360 degrees with manual positions. Other pedestals offer other features such as height adjustability. Very few of these pedestals incorporate any kind of suspension to reduce the shock on the passenger. What is desired is a suspension assembly that can be easily incorporated into new pedestals or have the capability of being retrofitted to an existing pedestal structure. Such an assembly should be lightweight, and have an uncomplicated design that can be maintained rarely by unskilled persons. In addition, the structure should allow the seat to rotate with respect to the base of the pedestal and employ features that offer lateral side-to-side stiffness that won't allow the seat to wobble while providing a smooth vertical suspension motion during use.

2. Description of the Prior Art

Various types of boat seat pedestals have been described. In U.S. Pat. No. 5,746,152, Huse describes a typical pedestal for a boat seat. Other variations including adjustability are including in U.S. Pat. Nos. 7,017,872 B2 and 6,138,973 (Woodward). Several inventions for suspension seats exist. In U.S. Pat. No. 7,008,015 B2 Bischoff describes a boat seat assembly between the seat frame relative to the base for purposes of regulating the motion of the seat frame. U.S. Pat. No. 2,893,470 to Peller discloses an adjustable seat with shock absorbing capabilities using a spring and hydraulic shock absorber coupled between two telescoping cylinders. This system also includes an anti-rotational mechanism consisting of a bar mounted to one cylinder that slides within a corresponding groove in the other cylinder. Use of shock absorbing apparatus is also described in U.S. Pat. No. 1,400,974 Parker which discloses two pedestals underneath the seating surface.

In addition, various suspension systems have been proposed and developed especially for bicycles. Many of these systems utilize a pair of telescoping assemblies between which the front wheel is mounted. Each assembly comprises an outer tube and an inner tube which is free to move in and out of the outer tube and is cushioned by a damper of one sort or another. The outer tubes are connected at the lower ends to the bicycle axle of the front wheel and the upper ends of the inner tube are connected together in a fashion similar to the usual upper end of a bicycle fork.

As is known to those skilled in the art, these types of suspension systems use anti-friction bushings to allow free movement of the inner tube within the outer tube. These types of suspension systems are easy to fabricate and produce at low cost making them popular. The bushings by themselves, however, have undesirable static friction called “stiction.” Because of this, the suspension systems using only bushings tend to stick and release. Such systems would be potentially worse for a boat seat as the full weight of a person must be supported compared to a bicycle where typically less than 50% of the weight of a person is suspended on the front suspension assembly. Any off axis force on a boat seat would cause a higher degree of stiction, rendering a bushing only approach limited in performance. In addition, in order to provide the ability to prevent rotation of the seat while using the suspension, the bushing system would need to be non-round so as to be able to impede any rotational movement yet allow the seat system to move vertically as desired.

A prior art example of a system which overcomes the stiction problem is shown in Farris et al. U.S. Pat. No. 5,320,374. In this example an improved form of suspension system is described using an outer tube and an inner tube connected to the fork of the bicycle which telescopes within the outer tube. The inner surface of the outer tube and the outer surface of the inner tube each have more than three arranged opposing longitudinal flat sections (typically four) on each tube. A corresponding number of hardened steel inner race shims are positioned longitudinally on the flats of the inner tube. A corresponding number of hardened steel outer race shims are positioned longitudinally on the flats of the outer tube. A corresponding number of needle bearings are disposed between the tubes in between the respective inner and outer race shims. This arrangement allows the two tubes to freely telescope in and out with respect to one another without any significant static friction and also serves to transmit the torsional force from the outer tube to the inner tube.

### SUMMARY OF THE INVENTION

The present invention provides a mechanism that can be either retrofitted to or provided in an existing seat pedestal for means of mitigating the shocks on a person sitting on a seat attached to the pedestal.

It is an advantage of the present invention that the mechanism controls the motion of the seat.

It is another advantage of the present invention that the mechanism not allows rotation of the seat relative to the pedestal base, provide suspension of the seat, and yet minimize cost, weight and static friction.

It is another advantage that the seat damping mechanism incorporate an air spring allowing the individual to adjust stiffness of the damping mechanism based on individual preference.

It is another advantage that the mechanism incorporate a mounting means that provides for coaxial orientation of the suspension mechanism and the seat pedestal.

### BRIEF DESCRIPTION OF THE DRAWINGS

FIG. 1 shows a simplified view illustrating the preferred form of the telescoping mechanism.

FIG. 2A shows an exploded view of the telescoping mechanism illustrating outer and inner tubes and assembly components

FIG. 2B shows a cross sectional view illustrating the relation of the outer and inner tubes of the mechanism.

FIG. 3A shows an overall view of the expansion bushing particularly the slotted outer tube that expands when forced from the inside.

FIG. 3B shows the relationship of the two expansion bushing tubes particularly the beveled features that cause the outer tube to expand when the inner tube wedge increases.

FIG. 4 shows a cross-sectional view illustrating the damping mechanism interior relative to the inner and outer tubes.

### DETAILED DESCRIPTION OF THE INVENTION

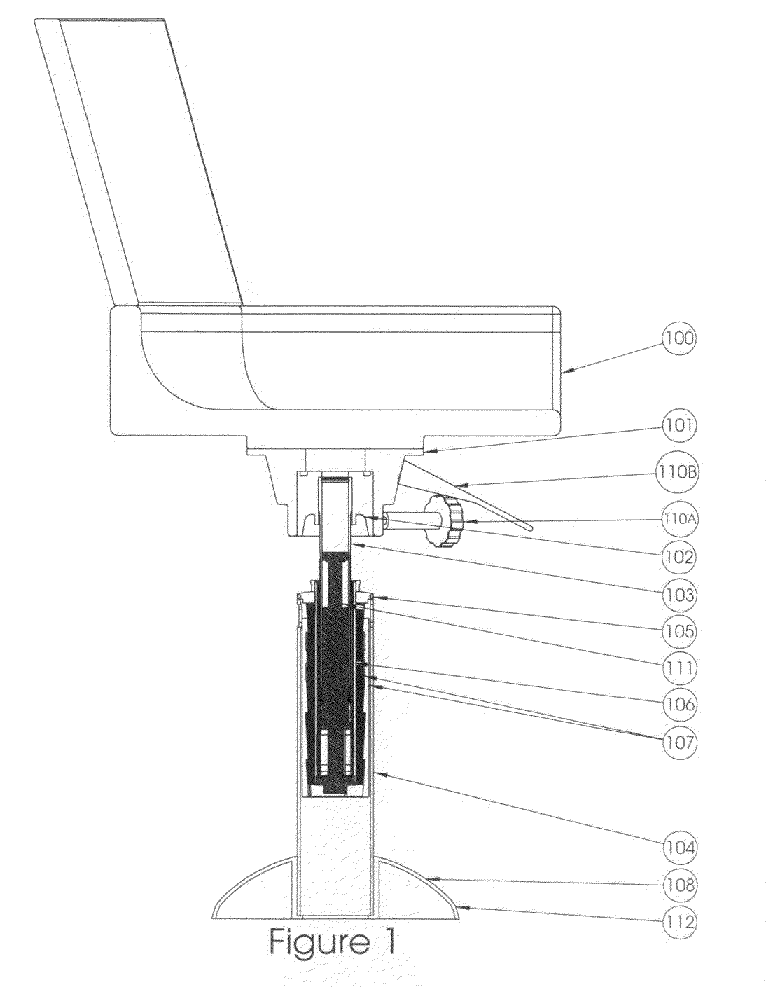

FIG. 1 shows a seat 100 attached to a rotation adjustment mechanism 101. A bushing 102 is designed to fit into the rotation adjustment mechanism 101. Inner tube 103 of a telescoping assembly is affixed to bushing 102. When the knob 110A is locked, the rotational adjustment mechanism 101 is firmly fixed to bushing 102, which is affixed to the telescoping assembly. When lever 110B is opened, the seat is free to rotate. A pedestal base assembly 108 consisting of a pedestal tube 104 and base 112 is attached to a boat deck. Outer tube 106 of the telescoping assembly is attached to pedestal tube 104 using a cap 105. Cap 105 is attached by threads to the expansion bushing assembly 107 and outer tube 106 of the telescoping assembly. The purpose of the bushing assembly 107 is to expand so that it can fit pedestal tubes 104 with differing internal dimensions, and in so doing affix firmly to the pedestal tube 104. When cap 105 is rotated by use of a spanner wrench, the expansion bushing assembly 107 expands so that the shock absorber solidly grasps the pedestal base tube 104 while it serves as a guide to keep outer tube 106 on the central axis of the assembly.

Outer tube 106 and inner tube 103 are coaxial and designed to telescope with respect to each other. Housed within outer tube 106 and inner tube 103 is a damping mechanism 111. As the seat is compressed or extended relative to the boat deck, the seat 100, inner tube 103 and tube 106 telescope and extend or compress relative to each other. The damper mechanism 111 either extends or compresses in unison with the compression of outer tube 106 and inner tube 103.

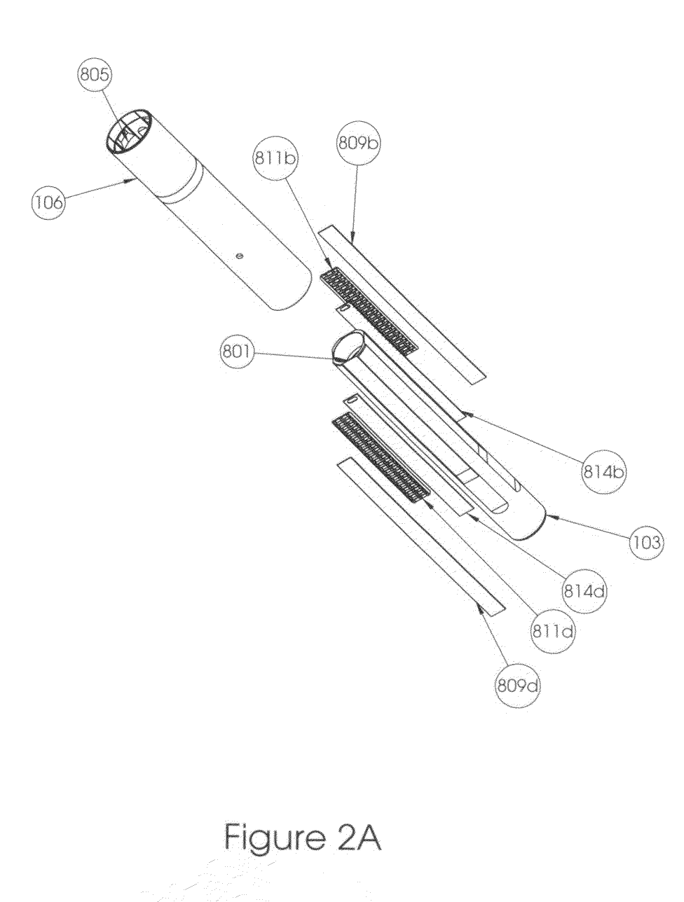

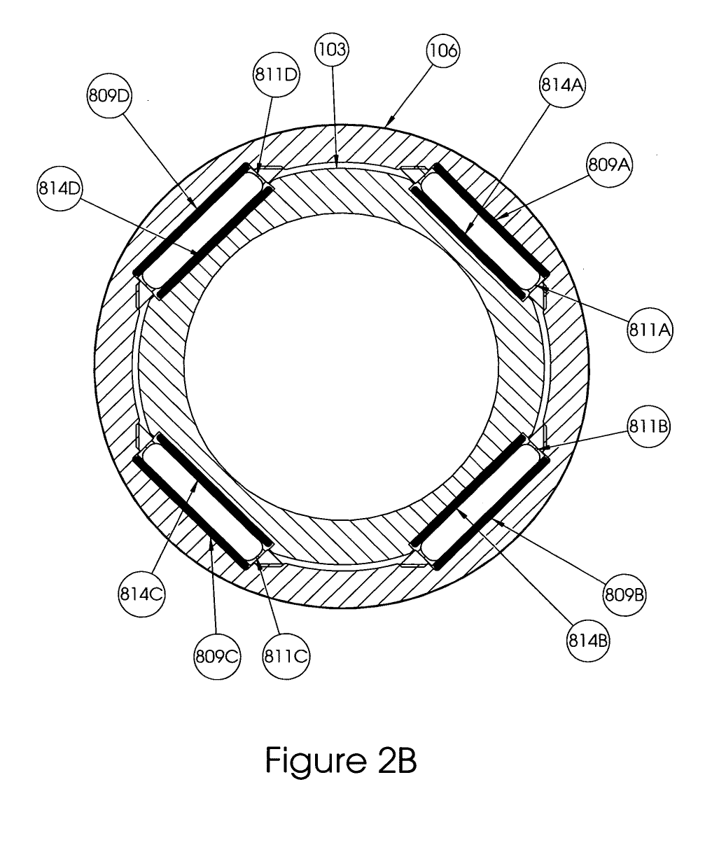

FIG. 2A is a view of the telescoping assembly showing parts germane to this invention. The outer wall of the inner tube 103 depicts a plurality of axially extending longitudinal flat surfaces or flats of which one is shown 801. In the preferred embodiment there are four such flats spaced 90 degrees peripherally, however there can be one or more flats used. In the inner wall of the outer tube 106, there are axially extending flats of which one is shown 805 that are opposing the corresponding flats on the inner tube. Contained between the inner and outer tube sets of four flats are an equal number of outer races of which two are shown 809b, 809d, an equal number of bearing needle assemblies of which two are shown 811b, 811d and an equal number of inner races of which two are shown 814b, 814d. The inner and outer races are commonly made of hardened carbon steel or stainless steel. There are a corresponding number of sets of bearing needle assemblies with the number of flats on the outer tube and inner tube. In the preferred embodiment there are four bearing assemblies.

FIG. 2B shows a cross-sectional view of the preferred embodiment of the telescope highlighting the relationship of the inner tube 103, the outer tube 106, the inner races 814A-D, the outer races 809A-D, and the needle bearing assemblies 811A-D.

The needle bearing assemblies 811A-D allow the inner tube 103 to travel freely in an axial direction with respect to the outer tube 106. Additionally, the needle bearing assemblies 811A-D in conjunction with the inner races 814A-D, outer races 809A-D which are imbedded in their respective flats, and outer tube 106 create rotational rigidity in that forces acting to rotate the seat are imparted on the needle bearing assemblies 811A-D which prevent such rotation.

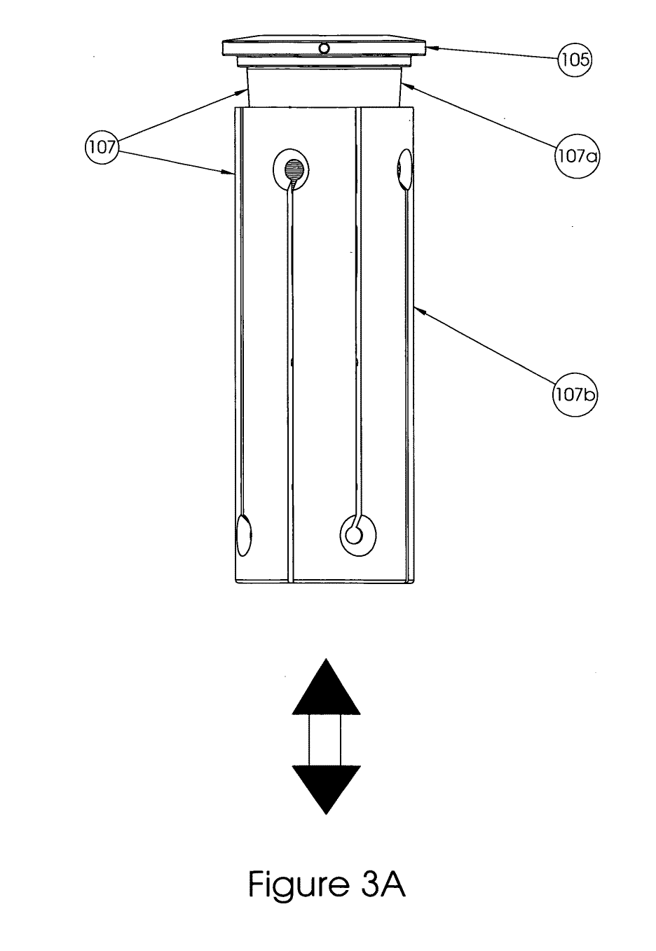

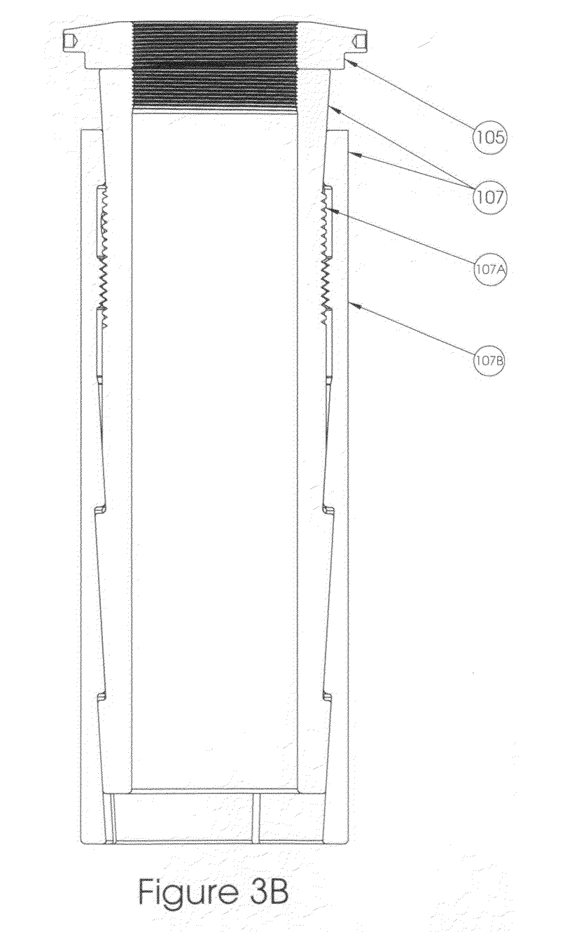

FIG. 3A shows a detailed view of the expansion bushing assembly 107 comprised of outer bushing member 107B which is slotted and inner bushing member 107A, with cap 105.

Outer bushing member 107B expands or contracts when inner bushing member 107A is moved axially with respect to 107B.

FIG. 3B shows a cross-section of expansion bushing assembly 107 comprised of inner and outer bushing members 107A and 107B and cap 105. The outer bushing member 107B is slotted so that it is free to expand its outside diameter. By turning the cap 105 clockwise, the inner bushing member 107A is moved so that the sloped surfaces of 107A and 107B wedge against each other, expanding outer bushing member 107B against the pedestal tube 104 providing coaxial orientation of the pedestal tube and bushing assembly.

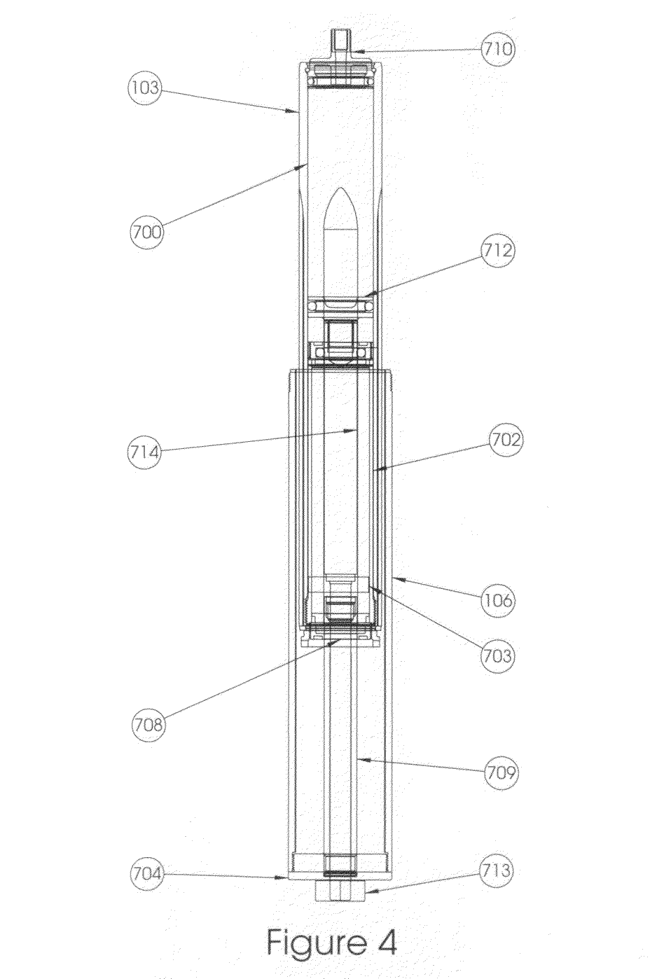

FIG. 4 shows a cross-sectional view of the damping mechanism housed in the telescoping mechanism. Inner tube 103 contains a damper cartridge 702 in which oil is disposed and an air chamber 700 in which high pressure air or nitrogen is disposed. During compression of the seat, inner tube 103 moves coaxially in outer tube 106 so as to bring the two tubes together. During rebound of the seat, inner tube 103 moves coaxially away from outer tube 106 back to the extended position. Housed within the damper cartridge 702 is a thrushaft 714 and a main shaft 709. The thrushaft and main shaft are attached to the outer tube 106 via an outercap 704 which is screwed to outertube 106. Thrushaft 714 is contained within the main shaft 709 and attached to outer cap 704 via a lock nut 713. Main shaft 709 slides within the damper cartridge thru a seal cap 708, the seal cap containing o-rings and seals to prevent the oil from leaking out of the damper cartridge 702. Attached to the other end of main shaft 709, is a cartridge oil piston 703. As is known to those familiar with cartridge damping, the oil piston 703 contains holes to allow fluid flow across the piston. As the seat is compressed, the cartridge oil piston 703 moves upward forcing oil through these holes. Likewise as the seat rebounds to the extended position, the oil moves back in the opposite direction across the oil piston 703. During compression of the seat, thrushaft 714 moves through a lower seal cap 705. Attached to the end of thrushaft 714 is an air piston 712. Air piston 712 and air schraeder fitting 710 attached to the end of inner tube 103 define air chamber 700. Air is introduced into air chamber 700 via the fitting 710 to provide an air return spring. Air piston 712 slides coaxially within inner tube 103. As the seat is compressed, air piston 712 moves closer to Schrader fitting 710 increasing the pressure in chamber 700. As the seat rebounds, the air piston 712 moves back to the extended position.

What is claimed is:

1. A suspension seat mechanism comprising:
an inner tube and outer tube co-axially mounted together to telescope with respect to each other, the inner tube having an outer wall with at least two or more axially extending longitudinal flat surfaces, the outer tube having an inner wall with a like number of corresponding flat surfaces as the inner tube;
a like number of inner race shims located longitudinally along the flat surfaces of the inner tube;
a like number of outer race shims located longitudinally along the flat surfaces of of the outer tube;
a like number of needle bearings located longitudinally between inner and outer race shims whereby the flat surfaces of the inner and outer tubes in combination with the needle bearings allow the inner and outer tubes to telescope with respect to each other;
a damping means to dampen the movement between said inner tube and outer tube;
a means of fixing the seat to the inner tube;
a means of fixing the outer tube to the floor.

2. A suspension seat mechanism as in claim 1, wherein said fixing means to fix the outer tube to the floor comprises:
a seat tube and pedestal for the purposes of housing the suspension seat mechanism said seat tube and pedestal being assembled together and mounted to the floor;
an expansion bushing comprising an inner and outer member located within the seat tube, wherein the inner member expands or contracts the outer member as it is moveably engaged with respect to the outer member cooperating to provide varying friction of the outer member against the inner wall of the seat tube; and wherein the outer tube of the seat assembly is engaged to the inner member and the outer member in a co-axial manner for the purposes of securing or removing the outer tube to or from the seat tube while maintaining a co-axial relationship of the seat tube and outer tube.
